(19) United States
(12) Patent Application Publication
(10) Pub. No.: US 2007/0246286 A1
(43) Pub. Date: Oct. 25, 2007

(54) Rigid motor vehicle axle with integral connecting elements

(76) Inventor: Steffen Henze, Lutherstadt Wittenberg (DE)

Correspondence Address: KLAUS J. BACH, 4407 TWIN OAKS DRIVE, MURRYSVILLE, PA, 15668, US

(21) Appl. No.: 11/702,416

(22) Filed: Feb. 5, 2007

(30) Foreign Application Priority Data
Feb. 7, 2006 (DE) 10 2006 005 773.2
Apr. 13, 2006 (DE) 10 2006 017 421.6

(51) Int. Cl. B60K 17/04

(52) U.S. Cl. 180/349

(57) ABSTRACT

In a rigid motor vehicle axle comprising an axle body which is hollow in at least some regions and which has two adapter tube sections joined together from half shells along a longitudinal assembly joint by welding, with axle-supporting and axle-guiding components being fastened in the region of the adapter tubee sections, the respective adapter tube section has at least two recesses and at least one connecting element is partially housed and restrained within the hollow regions of the axle and extends outwardly through the recesses with a form fit. The adapter pipe section and the connecting element are connected to each other along an insertion joint with a cohesive material joint, for example, proximate the adapter tube section recesses. In such a vehicle axle, any failure of the material joint does not result in a breakdown so that the vehicle is still operable for some time.

### BACKGROUND OF THE INVENTION

The invention relates to a rigid motor vehicle axle comprising an axle body which is hollow at least in some regions and has two adapter pipe sections joined together from half shells along a longitudinal assembly joint by welding, with axle-supporting and axle-guiding components being fastened or coupled in the region of the adapter pipe sections.

German Patent No. DE 103 37 193 A1 discloses a rigid vehicle axle of this type. In each of the outer regions, the axle body of the rigid axle has an axle pipe section which is comparable to the adapter pipe section previously mentioned. Each axle pipe section is formed from two half shells, with them being welded to each other along their longitudinal assembly joint. For the fastening of axle-supporting and/or axle-guiding components, a plurality of fastening sleeves are welded laterally to the axle pipe sections. As an alternative to this, in another variant embodiment, special saddle-shaped adapter elements are fastened to the upper and lower sides by welding. The fastening of these connecting elements by welding has the disadvantage that, if a weld fractures, the rigid axle can become detached from the vehicle body in an uncontrolled manner.

It is an object of the present invention to overcome the prior art problem by developing a rigid vehicle axle, the connecting elements of which—despite being welded to the axle body—follow the design principle of “limited failure”. The construction space required by the axle is not to be enlarged.

### SUMMARY OF THE INVENTION

In a rigid motor vehicle axle comprising an axle body which is hollow in at least some regions and which has two adapter pipe sections joined together from half shells along a longitudinal assembly joint by welding, with axle-supporting and axle-guiding components begin fastened or coupled in the region of the adapter pipe sections. For this purpose, the respective adapter pipe section has at least two recesses. At least one connecting element is partially housed within the hollow regions of the axle and extends outwardly through the recesses with a form fit. The adapter pipe section and the connecting element are connected to each other along an insertion joint with a cohesive material joint proximate the adapter pipe section recesses.

The present invention develops a rigid vehicle axle, the connecting elements of which provide limited failure despite being connected to the axle body with a cohesive material joint.

For this purpose, the respective adapter pipe section has at least two recesses per wheel side of the axle body. At least one connecting element is inserted into the recesses per wheel side of the axle body—with a form fit and, if appropriate, with a relatively large amount of play—with an assembly joint being produced between the connecting element and the respective adapter pipe section. The adapter pipe section and the connecting element are connected to each other along the assembly joint with a cohesive material joint. In the event of a relatively large amount of play between the connecting element and the respective adapter pipe section, the connection, which is designed, for example as a weld, is to be provided in a centering device. Alternatively, the components to be joined can be machined in such a precise manner that the components can be joined together with a form fit in a manner largely free from play and a connection in a centering device can be dispensed with.

Accordingly, there is at least one connecting element in the form of an insert in each wheel-side axle body half. The connecting element, which is inserted into corresponding recesses of the half shells with a form fit and protrudes, for example, to the front and rear, is integrated nondetachably in the axle body during the production of the welds connecting the half shells with a cohesive material joint. The form fit already prevents separation of the components. In addition, the connecting element is connected all around along the edges of the recesses to the axle body with a cohesive material joint, for example, by means of a welding process.

The construction principle of limited failure is thereby realized for the connection of the axle-guiding and axle-supporting components. Should, in the event of an overloaded rigid axle, a connection, such as, for example, a weld, tears in the connecting element region of the adapter pipe section which, among other things, is loaded to the maximum by bending, although the axle-guiding and axle-supporting components may become loose, this does not lead to loss of the axle because of the form fit. According to the principle of limited failure, an extremely hazardous failure of the connection, such as, for example, of a weld, is therefore permitted during the vehicle use time without severe consequences being able to occur as a result. The vehicle driver becomes aware of a defective weld at the latest during the daily routine check due to a loss of oil from the axle. In the case of nondriven axles, the axle bodies of which as a rule do not receive any lubricating oil, unmissable rattling noises arise in the damaged axle body region at the latest when the vehicle is next idling.

Further details of the invention will become more readily apparent from the following description of the expedient embodiments thereof on the basis of the accompanying drawings.

### BRIEF DESCRIPTION OF THE DRAWINGS

FIG. 1 is a perspective view of an axle body of sheet-metal construction with integrated connecting element;

FIG. 2 is an exploded perspective view of half shells of the driver-side adapter pipe section with connecting element;

FIG. 3 is a perspective view of closed half shells of the driver-side adapter pipe section without connecting element;

FIG. 4 is the same as FIG. 3, but without opposite recesses;

FIG. 5 is the same as FIG. 3, but with recesses in the central half shell region;

FIG. 6 is a perspective view of a half axle body with spring console;

FIG. 7 is a cross-sectional view of a stiffened adapter pipe section. The subject matter shown is divided centrally in order to illustrate the front and rear axle sides;

FIG. 8 is a cross-sectional view of an asymmetrical connecting element with link connection;

FIG. 9 is a cross-sectional elevational view of a connecting element in an H shape;

FIG. 10 is a plan view of FIG. 9 without the upper halfshell;

FIG. 11 is a cross-sectional elevational view of a connecting element with shackle; and

FIG. 12 is a cut-away plan view of FIG. 11 without the upper half shell.

### DESCRIPTION OF THE PREFERRED EMBODIMENTS

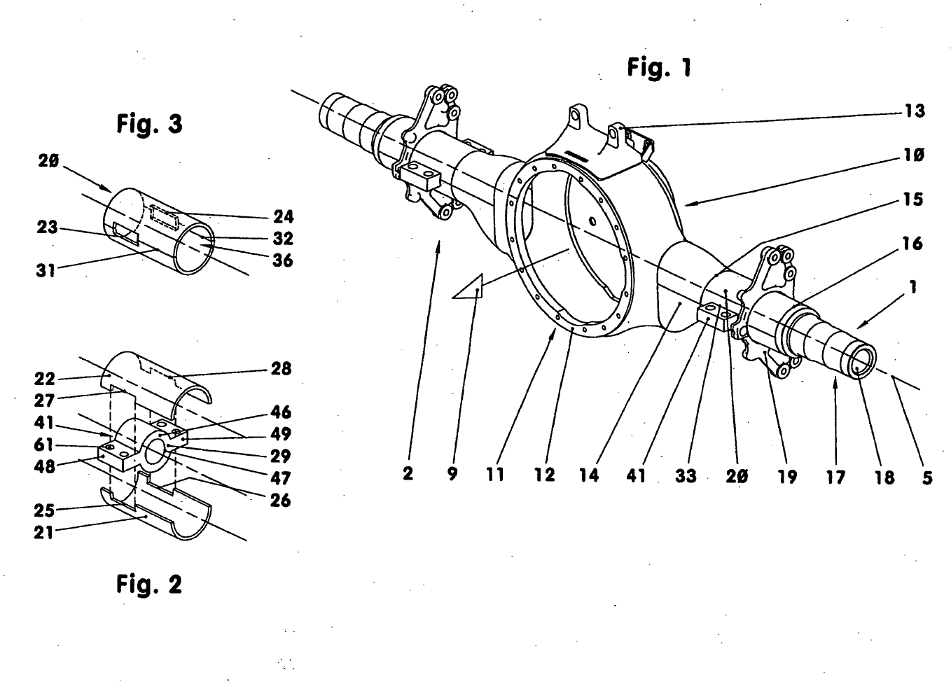

FIGS. 1 and 6 show by way of example two different axle bodies (10, 110) which can each be part of a driven rigid axle of a commercial motor vehicle. In this case, this axle may also be a steering axle.

According to FIG. 1, the axle body (10) illustrated comprises the cylindrical casing (12) of differential housing (11), two adapter pipe sections (21, 22) shown in FIG. 2, two axle stubs (18) as outer axle body end pieces (17) and two connecting elements (41).

The cylindrical casing (12), for example manufactured as a sheet-metal part, sits, if appropriate, centrally, in the geometrical center of the axle body (10). A bearing bracket (13), for example, is arranged on the cylindrical casing (12). This bearing bracket (13) is used to support the axle body (10) on the vehicle frame via a wishbone (not illustrated). At the sides, the cylindrical casing (12) has a respective large opening with, for example, an oval cross section. A funnel-like intermediate piece (14), for example, is welded on at this location. It ends in a flat end-face joining contour (15) in the shape of a circular ring.

The adapter pipe sections (20) adjoin the intermediate pieces (14) on both sides at the respective joining contour (15). Each adapter pipe section (20) here comprises, for example, a lower and an upper half shell (21, 22), manufactured, for example, from steel sheet, see FIGS. 2 and 3. The two half shells (21, 22) are welded to each other and surround a cavity (36). The half shells (21, 22) are two identical halves of the adapter pipe section (20) only by way of example.

Towards the axle end piece (17), the adapter pipe section (20) ends in a cross section likewise, for example, in the shape of a circular ring. The axle end piece (17) is fastened there, for example, by friction welding. The joining contour (15) in the shape of a circular ring lies with its geometrical center on the axle body axis (5). In addition, it is oriented normally to the axle center line (5). In this exemplary embodiment, the same also applies to the joining contour (16).

In FIGS. 1 and 6, the axle end pieces (17) are a regular, tubular, multi-stepped axle stub (18).

A brake anchor plate flange (19) is fastened on each adapter pipe section (20), for example by welding. The individual brake anchor plate flange (19) is oriented normally to the axle center line (5). The brake lining support and brake caliper (not illustrated) are fastened to the individual brake anchor plate flange (19).

All of the axle body parts, including the axle stub (18), form a common cavity, which, if appropriate partially separated—below the drive half-shafts—by splash walls, constitutes a storage space for lubricant.

In the case of asymmetrical axle bodies, adapter pipe sections (20) of different length are arranged between the intermediate piece (14) and the axle stubs (18).

Pursuant to the present invention, in the adapter pipe section (20), as shown in FIGS. 1 & 2, there are provided two recesses (23, 24) for receiving the connecting element (41) to be inserted, see FIG. 3. This connecting element (41), which is illustrated in simplified form here, essentially comprises a pipe (46) with two fastening tabs (48, 49). The pipe (46) has an outside diameter which is at least some millimeters smaller than the inside diameter of the adapter pipe section (20). It has a central bore (47) for the passage of the drive half-shaft (7) not shown in FIG. 2. Its center line is congruent to the center line (5) of the axle body (10). The fastening tabs (48, 49), which have a plurality of fastening bores (61), protrude from the pipe (46) to such an extent that, after arrangement and fastening in the adapter pipe section (20), there is sufficient space on the respectively projecting tabs (48, 49) for at least screws or nuts to be supported and tightened or screwed down.

According to FIG. 2, each recess (23, 24) comprises two partial recesses, see FIG. 3. The lower half shell (21) has the partial recesses (25) and (26) while the upper half shell (22) has the partial recesses (27) and (28). The individual identical partial recesses (25, 27; 26, 28) border the corresponding longitudinal assembly joints (31, 32). The half shells (21, 22) and the connecting element (41) are mirror-symmetrical, both with respect to a plane defined by the longitudinal assembly joints (31, 32) and with respect to a plane which is perpendicular to the first plane and is placed on the center line (5).

During the production process of the axle body (10), the individual connecting element (41) is placed between the half shells (21, 22) in order subsequently to be fixed in the recesses (23, 24) during welding of the two longitudinal assembly joints (31, 32). In the region of the respective connecting element (41), the individual longitudinal assembly joint (31, 32) is divided into the assembly joint (33, 34) which is guided around the connecting element (41). The connecting element (41) is welded to the adapter pipe section (20) along the assembly joint (33, 34). All of the welds (71, 72) of this region are at least oil tight.

Regardless thereof, the longitudinal assembly joints (31, 32) and the assembly joints (33, 34) may also be three-dimensionally curved surfaces, so that the corresponding welds (71, 72) follow curves curved three-dimensionally.

In order to join together the individual pre-manufactured, if appropriate finished axle body parts, with as little distortion as possible, use is made, for example, of welding processes, such as laser or plasma welding. The welds (71, 72) tightly sealing the respective connecting element (41-45) to the half shells (21, 22) of the adapter pipe sections (20, 120) may be, inter alia, flat, curved or hollow welds. DHY welds are also conceivable.

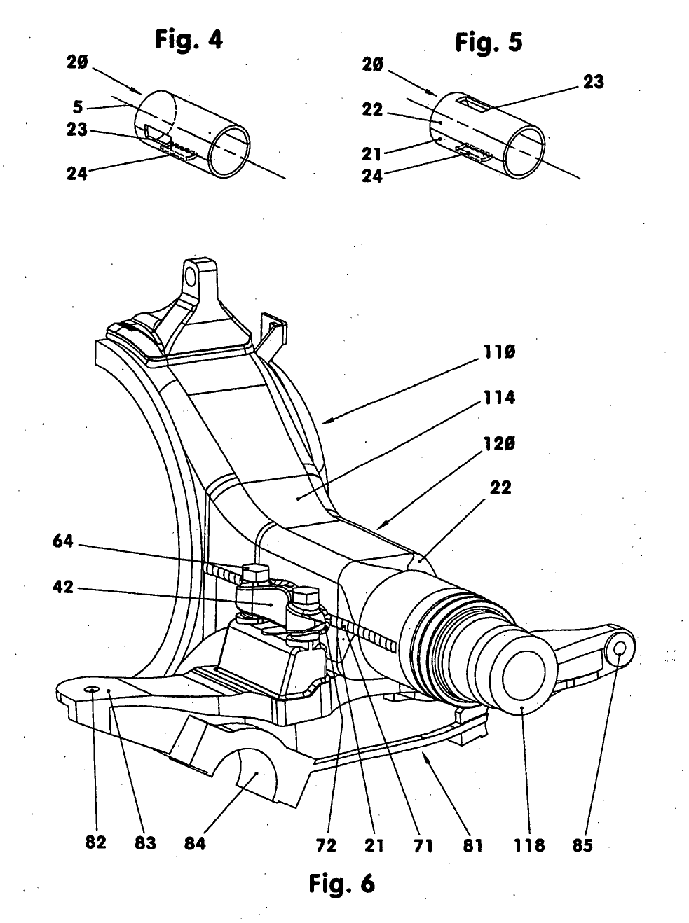

FIG. 4 shows an adapter pipe section (20), the recesses (23, 24) of which, with reference to the center line (5), are offset with respect to each other by 90 degrees of angle. The corresponding connecting element protrudes here forwards and downwards from the adapter pipe section (20). If appropriate, the connecting element may also have three fastening tabs, with the third fastening tab then in turn protruding on the axle side (4)—like the fastening tab (49) shown in FIG. 2.

According to FIG. 5, the recesses (23, 24) are situated in each case in the central region of the corresponding half shells (21, 22). The connecting element (41) from FIG. 3 can be positioned here—pivoted through 90 degrees of angle about the center line (5)—into the axle pipe section (20) and welded.

FIG. 6 shows the driver's side half of an axle body (110) with a spring console (81) screwed on. An adapter pipe section (120) which in some regions is in the shape of a square pipe is arranged here on the intermediate piece (114) which is connected downstream of the cylindrical casing. A connecting element (42) is positioned between the upper half shell (22) and lower half shell (21) of the adapter pipe section (120). The axle stub (118) adjoins the adapter pipe section (120) in a known manner. In the region between the connecting element (42) and the axle stub (118), the square pipe cross section of the adapter pipe section (120) merges into a cylindrical pipe section.

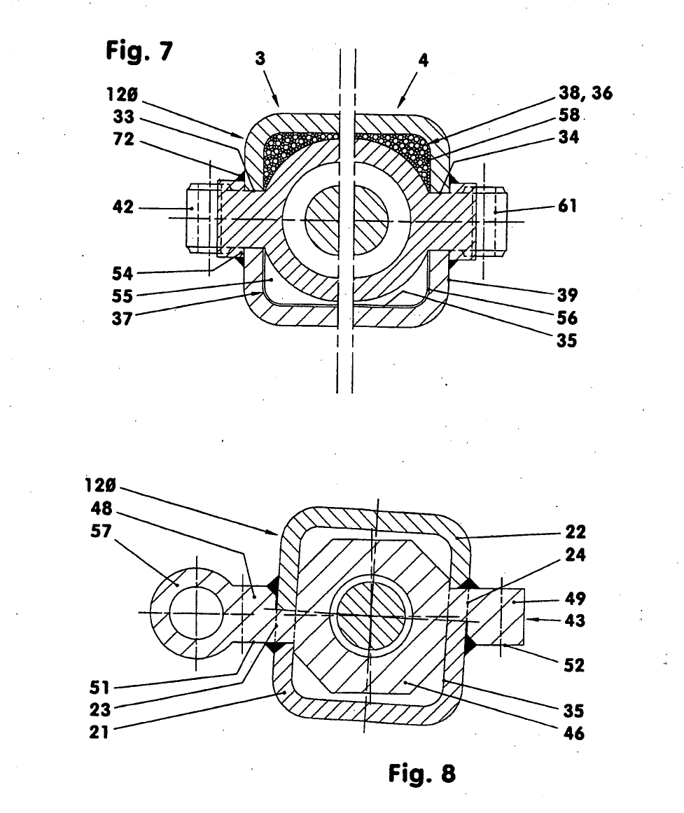

The connecting element (42) which is arranged centrally between the half shells (21, 22) in the vertical direction has, in the region in which it penetrates the adapter pipe section (120), an at least approximately rhomboidal cross section with rounded corners, with the result that the component wall thickness between the fastening bores (61), see also FIG. 7, is greater than in the region of the fastening bores (61). This cross-sectional shape necessitates, in the case of the recesses (23, 24), corresponding cross-sectional shapes which load the half shells (21, 22) only with a low notch stress.

According to FIG. 7, the connecting element (42)—as seen in the longitudinal direction of the vehicle—is of narrower and higher design between the fastening bores (61). The connecting element (42) has a larger cross section out-side the recesses (21, 22), with the result that the connecting element (42) wraps around the outer wall (39) of the adapter pipe section (120) by some millimeters. By means of this wraparound (54), the connecting element (42) is positioned in the half shells (21, 22) before the welding. The wraparound (54) also relieves the welds (72) from load.

According to FIG. 7, the connecting element (42) has upper and lower boundary webs (55) in the cavity (36) in the region of its end sides (29). The boundary webs (55) protrude, forming a gap (56), up to the inner wall (35) of the adapter pipe section (120). An intermediate space (37, 38) is produced at the bottom and top between the boundary webs (55) and the inner wall (35).

The intermediate spaces (37, 38) are partially filled, for example, with an “APM aluminium foam”. The APM foam is a bonded mixture of premanufactured, small-volume metal foam elements (58). The metal foam elements (58) are, for example, in each case balls of identical size. The smallest diameter of the metal foam elements is smaller in this case than the gap (56). The metal foam elements (58) are encased with adhesive or are introduced together with adhesive as a compact into the intermediate spaces (37, 38) to be filled with foam. The mixture is heated in the adapter pipe section (120) to approx. 180° C. In the process, the adhesive is activated. It connects the metal foam elements firstly to one another and secondly to the connecting element (42) and the adapter pipe section (120).

The bonded metal foam elements (58) therefore have a stiffening and noise-damping effect. As an alternative to this, a metal foam or another curing adhesive compound can be sprayed into the intermediate spaces (37, 38) via certain bores. In FIG. 7, the inserted APM foam is not illustrated in the lower intermediate space (37).

The spring console (81), as shown in FIG. 6, bears against the lower side of the connecting element (42). For this purpose, the spring console (81) wraps around the adapter pipe section (120) in the lower quarter of a cross section. The spring console (81) is, for example, a type of support with a partially T-shaped and partially I-shaped cross section. A bore (82) via which a spring element (not illustrated) is fastened is located in each case in the region of the front, free end of the spring console (81). This bore (82) is situated in the center of the spring support surface (83), which is planar at least in some regions. In the case of a vehicle in the construction position, the spring support surface (83) is oriented at least approximately parallel to the carriageway surface. Below the front end of the spring console (81) a bearing bracket (84) is illustrated in the form of a clip for the coupling of an axle-guiding, lower link or stabilizer. At its rear end, the spring console (81) bears a joint eye (85) which serves, for example, for the supporting of a shock absorber or for the coupling of a link.

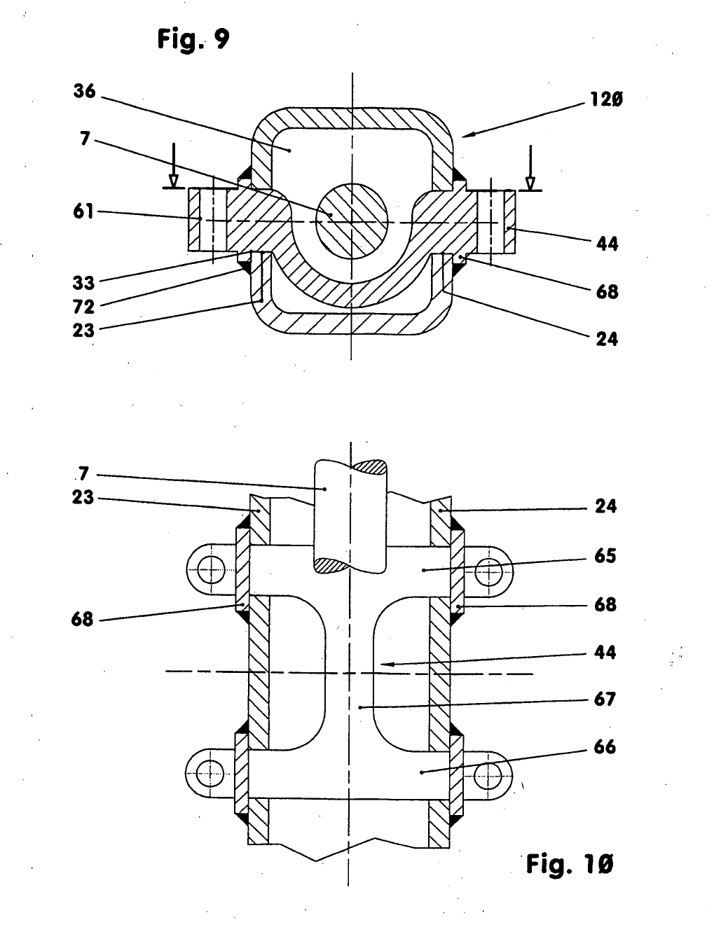

FIGS. 9 and 10 show an H-shaped clamp as the connecting element (44). The H clamp (44) comprises two transverse clamps (65, 66) which are connected to each other via a clamp web (67). The individual transverse clamp (65, 66) runs through the cavity (36), for example curved semicircularly below the drive half-shaft (7). It protrudes from the recesses (23, 24) on both sides. A fastening bore (61) is arranged in the region of each end. A clamp flange (68) which covers the assembly joint (33, 34) is located—as in the case of the subject matter of FIG. 7—between each fastening bore (61) and the outer wall of the adapter pipe section (120). The welds (72) run along the clamp flange (68). If appropriate, the H clamp can also be designed as a Y clamp. Two transverse brackets would then protrude, for example, on the front axle side (3) while only one transverse clamp protrudes from the corresponding recess on the rear axle side (4).

As a further variation, the clamp web (67) can be omitted, and so, for example, two separate transverse clamps (65, 66) situated next to each other are used.

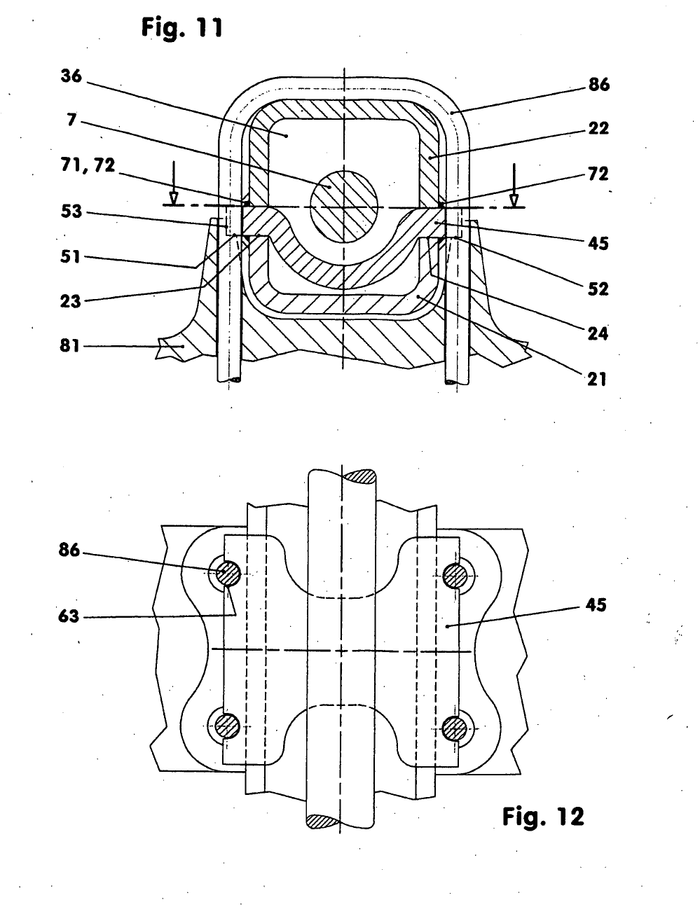

FIGS. 11 and 12 illustrate a connecting element (45) which is in the shape of a fitted handle. Its cross section is partially comparable to a transverse clamp from FIGS. 9 and 10. However, the connecting element (45) does not have any clamp flanges and any fastening bores. Instead of the fastening bores, the clamp (45) has four notch-like recesses (63) oriented in the longitudinal direction of the vehicle. The individual recess (63) has a U-shaped or semicircular cross section. The recess (63) wraps in some regions around the cross section of a shackle (86) which fixes the spring console to the axle body, with the result that, even after the shackles (86) are loosened, the spring console (81) cannot slip in the transverse direction of the vehicle.

The adapter pipe section (120) bears with its lower stop surfaces (51, 52) of the connecting element (45) against the spring console (81). According to FIG. 11, the clamp (45) makes contact with the spring console (81) also over at least approximately vertical stop surfaces (53).

In the case of the variant according to FIGS. 11 and 12, the upper half shell (22) does not have any partial recesses. The recesses (23, 24) are placed entirely into the lower half shell (21), and so the weld (71) is aligned with the upper region of the weld (72).

By contrast, the adapter pipe section (120), of FIG. 8, which receives a connecting element (43) again has two identically shaped half shells (21) and (22). However, here the front recess (23) is only in the lower half shell (21) while the rear recess (24) is located only in the upper half shell (22). In addition, the adapter pipe section (120) is tilted with respect to the stop surfaces (51, 52) by, for example, 3 degrees of angle. The octagonal pipe (46) of the connecting element (43) is also centered on the inner wall (35) of the adapter pipe section (120).

As a further characteristic, the connecting element (43) has a joint eye (57), for example for the coupling of a link or a connecting rod of a U-stabilizer. The joint eye (57) is integrally formed here on the front fastening tab (48). If appropriate, the connecting element (43) can also be used only as a support of the joint eye (57) or of a comparable functional part. Accordingly, the fastening tab (49) lying opposite the joint eye (57) does not have to protrude over the outer wall (39) of the adapter pipe section (120).

The connecting elements (41-45) can be used in the axle bodies of all types of rigid axles, such as, for example, of steered and unsteered, of driven and undriven axles or else of lift axles.

It is also conceivable not to weld but rather to adhesively bond the half shells (21, 22) along the longitudinal assembly joints (31, 32) and the assembly joints (33, 34). The same applies in particular if the corresponding axle body parts are to be manufactured from fiber-reinforced plastics or comparable composite materials.

What is claimed is:

1. In combination with a rigid motor vehicle axle comprising an axle body (10, 110) which is hollow at least in some regions and includes two adapter pipe sections (20, 120), each of the pipe sections (20, 120), formed together from half shells (21, 22) having a welded jointure along longitudinal assembly joints (31, 32), axle-supporting and axle-guiding components (81) in secure attachment in the region of the adapter pipe sections (20, 120), the improvement which comprises:
the respective adapter pipe section (20, 120) includes at least two recesses (23, 24) therein proximate wheel side (1, 2) of the axle body (10, 110),
a connecting element (41-45) is partially housed and restrained within the hollow regions of the axle body (10, 110) and extends outwardly through the recesses (23, 24) of the axle body (10, 110) with a form fit,
the connecting element (41-45) and the respective adapter pipe section (20, 120), having an assembly joint (33, 34) formed there-between,
the adapter pipe section (20, 120) and the connecting element (41-45) are joined to each other along the assembly joint (33, 34) by a cohesive material joint.

2. The rigid motor vehicle axle, according to claim 1, wherein the respective adapter pipe section (20, 120) has at least one recess (23, 24) per wheel side (1, 2) and per axle side (3, 4) of the axle body (10, 110), and has the individual recess (23, 24) per axle side (3, 4) at least one of bordered by the longitudinal assembly joint (31, 32) and intersected by it (31, 32).

3. The rigid motor vehicle axle according to claim 1, wherein the half shells (21, 22) of the adapter pipe sections (20, 120) are divided longitudinally.

4. The rigid motor vehicle axle according to claim 1, wherein the two half shells (21, 22) of the adapter pipe section (20, 120) of an axle side (3, 4) have a mirror-symmetrical design.

5. The rigid motor vehicle axle according to claim 1, wherein the connecting element (41-45) is arranged in the longitudinal direction of the vehicle between the half shells (21, 22) of the adapter pipe sections (20, 120) with a form fit.

6. The rigid motor vehicle axle according to claim 1, wherein each connecting element (41-45) has at least one stop surface (51-53) for at least one of axle-guiding and axle-supporting components (81).

7. The rigid motor vehicle axle according to claim 1, wherein each connecting element (41-45) has at least one of bores (61, 62) and notch-like recesses (63) on which at least one of fastening elements (64) of axle-guiding and axle-supporting components (81) are supported.

8. The rigid motor vehicle axle according to claim 1, wherein at least one of a vehicle spring suspension system and a spring console (81) for the mounting of spring elements and shock absorber elements and for the coupling of links or stabilizers is fastened to each connecting element (41-45).

9. The rigid motor vehicle axle according to claim 1, wherein the intermediate spaces (37, 38) between the connecting element (41-45) and the inner wall (35) of the adapter pipe section (20, 120) are filled in at least some regions with a mixture of premanufactured small-volume metal foam elements (58) and curing adhesive.

10. A rigid motor vehicle axle according to claim 9, wherein the connecting elements (41-45), have lateral boundary webs (55), which extend radially, with reference to the center line (5) of the axle body (11, 110), a predetermined distance so as to have gap (56) between the boundary webs (55) and the inner wall (35) of the adapter pipe section (20, 120), the radial extent of the gap (56) being smaller than the smallest diameter of the metal foam elements (58), whereby at least largely closed intermediate spaces (37, 38) are provided within the adapter pipe section (20, 120).
